(19) United States
(12) Patent Application Publication
(10) Pub. No.: US 2013/0098745 A1
(43) Pub. Date: Apr. 25, 2013

(54) BUTTON DEVICE

(71) Applicant: TSUNG-SHIH LEE, New Taipei (TW)

(72) Inventor: TSUNG-SHIH LEE, New Taipei (TW)

(73) Assignee: Cheng Uei Precision Industry Co., LTD., New Taipei City (TW)

(21) Appl. No.: 13/279,224

(22) Filed: Oct. 21, 2011

(51) Int. Cl. H01H 13/14

(52) U.S. Cl. 200/520

(57) ABSTRACT

Provided is a button device, including a button body and a circuit board. The button body includes a first surface provided for being pressed, and a bottom base being located on the left of the button body and extending downward from the first surface. The circuit board has an electronic switch for mechanically touching the bottom base of the button body. The button body forms two recesses on the middle and the right of the button body, respectively. Each of the recesses extends along a direction perpendicular to the first surface, and accommodates an elastic member therein. According to the button device of the present invention, a working force is applied onto any position of the button body, the counterforces may be produced to balance the working force, thereby improving the handle feeling of the user during the operation and solving the problem of the button body tilting.

### BACKGROUND OF THE INVENTION

1. Field of the Invention

The present invention relates to a button device, and more particularly to a button device being capable of horizontally moving downward in the operation.

2. Description of the Prior Art

Please refer to FIG. 1, a button device 98 of the prior art comprises a button body 20 and a circuit board 19. The circuit board 19 includes an electronic switch 10. The button body 20 forms a bottom base 31 on the bottom of the left side thereof, which is used to mechanically touch the electronic switch 10. But in the arrangement of the electronic device, the electronic switch 10 is disposed on the upper-left of the circuit board 19. Please further refer to FIG. 2A, when a user applies a working force 15 onto the left of an arc push surface 21 located on the top of the button body 20, the button body 20 will move downward and directly contact with the electronic switch 10 because the working force is concentrated onto the left of the button body 20. The electronic switch 10 will provide a counterforce to balance the working force 15, so in this state, the whole button body 20 may keep horizontally moving downward and the moving effect thereof is shown by a rectangular frame 18 in FIG. 2B. The rectangular frame 18 in FIG. 2B represents that the button body 20 can keep being horizontal and not tilt when moving downward. Further referring to FIG. 3A, when the user applies another working force 15 onto the middle of the arc push surface 21 of the button body 20, the counterforce will be first produced on the left of the button body 20 because the left of the button body 20 may directly contact with the electronic switch 10, but the middle and the right of the button body 20 can not produce the corresponding counterforce thereon, so that the counterforce produced on the left of the button body 20 will be difficult to balance the working force 15. As a result, the button body 20 will rotate clockwise according to the lever principle. Namely, the whole button body 20 cannot keep horizontally moving downward and the moving effect thereof is shown by the rectangular frame 18 in FIG. 3B. The rectangular frame 18 in FIG. 3B represents that the whole button body 20 will tilt toward the right side thereof. Please further refer to FIG. 4A, when the user applies another working force 15 onto the right of the arc push surface 21 of the button body 20, similarly the counterforce will be first produced on the left of the button body 20 because the left of the button body 20 may directly contact with the electronic switch 10, but the right of the button body 20 can not produce the corresponding counterforce thereon, so that the counterforce produced on the left of the button body 20 will be difficult to balance the working force 15. As a result, the button body 20 will rotate clockwise according to the lever principle. Namely, the whole button body 20 cannot keep horizontally moving downward and the moving effect thereof is shown by the rectangular frame 18 in FIG. 4B. The rectangular frame 18 in FIG. 4B represents that the whole button body 20 will tilt toward the right side thereof.

### BRIEF SUMMARY OF THE INVENTION

For solving the problem in the above prior art, an object of the present invention is to provide a button device being capable of horizontally moving downward in the operation.

To achieve the above object, in accordance with the present invention, a button device is provided, comprising a button body and a circuit board. The button body has a first surface, a second surface, a vertical wall and a bottom base. The bottom base is located on one side of the button body. The first surface is provided for being pressed.

The second surface is opposite to the first surface and located under the first surface. The second surface forms two recesses on the middle and the other side of the button body, respectively. Each of the recesses extends along a direction perpendicular to the first surface, and accommodates an elastic member therein.

The vertical wall extends downward from a peripheral edge of the first surface. The first surface and the vertical wall together define a hollow cavity therebetween. The second surface and the recesses are in the hollow cavity.

The bottom base extends downward from the first surface toward the second surface. The extension length of the bottom base is greater than that of the vertical wall.

The circuit board has an electronic switch, which is used to mechanically touch the bottom base of the button body.

According to the button device of the present invention, the length of the elastic member on the middle of the button device is less than that that of the elastic member on the other side of the button device.

According to the button device of the present invention, the elastic member may be a spring tube or a leaf spring.

Based on the above description, the button device of the present invention disposes the recesses and the elastic members accommodated therein. When a user applies a working force onto any position of the button body, the counterforces may be produced on the middle and the two sides of the button body to balance the working force, thereby avoiding resulting in the tilt of the button body when pressing the button body.

### BRIEF DESCRIPTION OF THE DRAWINGS

FIG. 1 is a structural schematic view of a button device in the prior art.

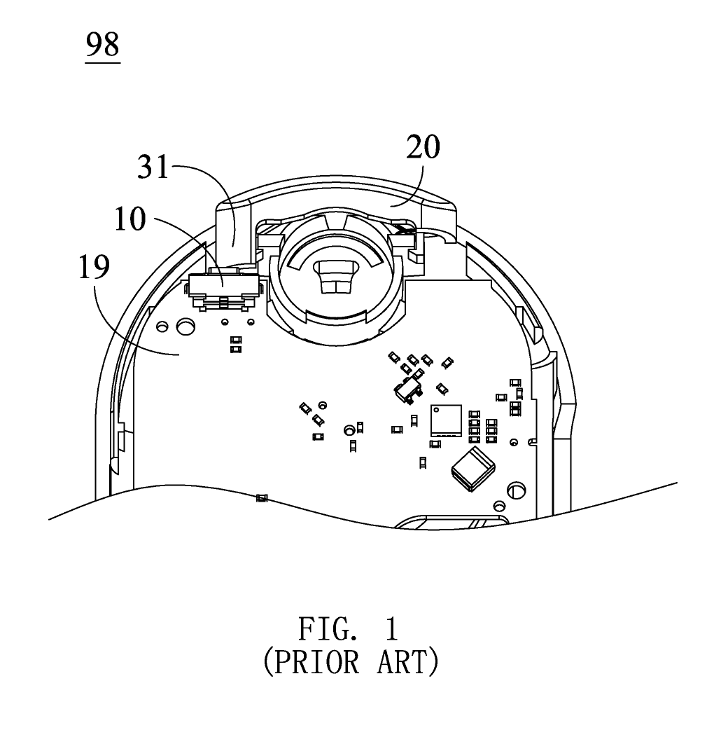

FIG. 2A is a structural schematic view of the prior button device, and shows that a working force will be applied onto the left side of a button body.

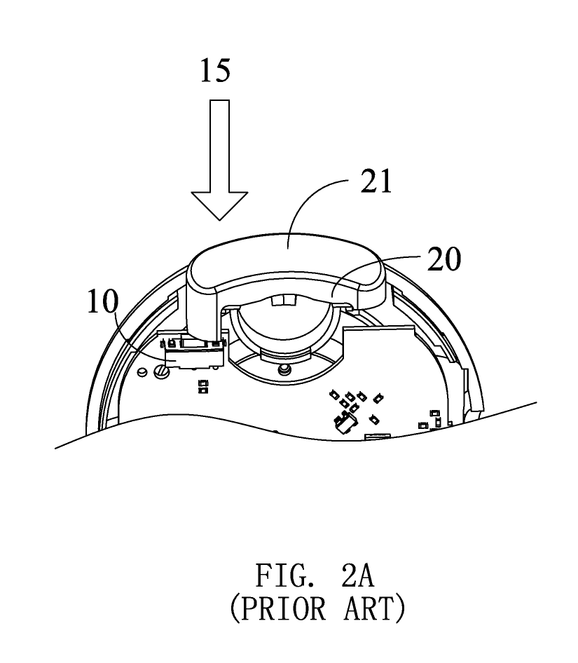

FIG. 2B is a structural schematic view of the prior button device after the working force is applied onto the left side of the button body.

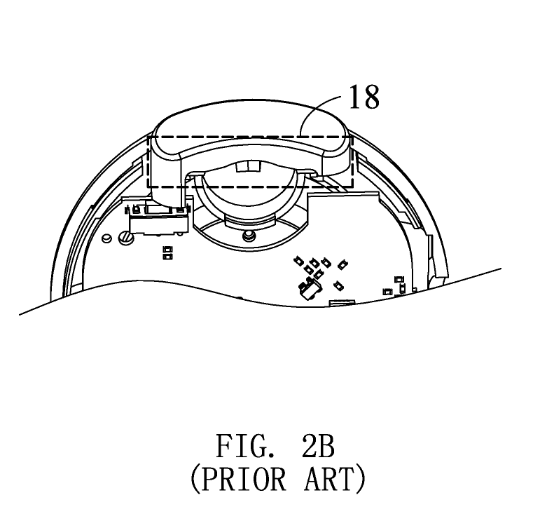

FIG. 3A is a structural schematic view of the prior button device, and shows that the working force will be applied onto the middle of the button body.

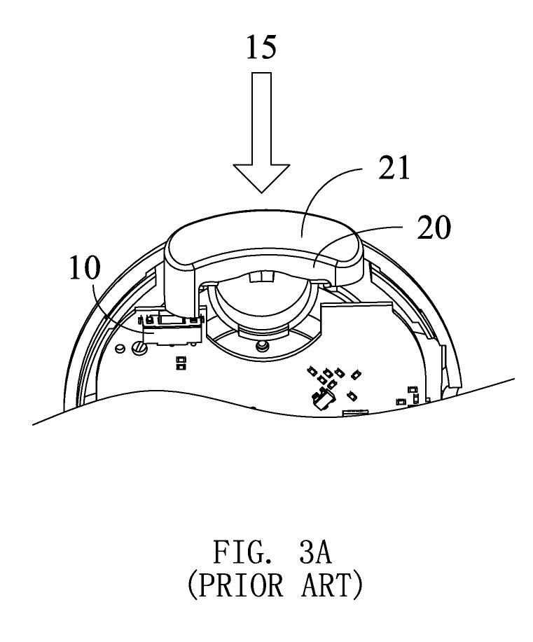

FIG. 3B is a structural schematic view of the prior button device after the working force is applied onto the middle of the button body.

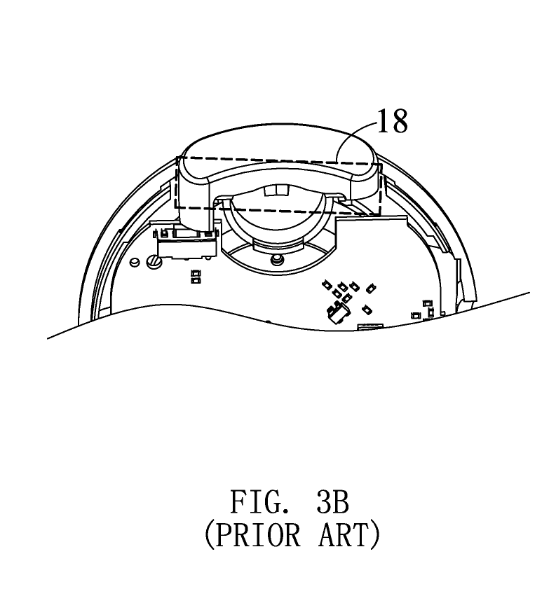

FIG. 4A is a structural schematic view of the prior button device, and shows that the working force will be applied onto the right side of the button body.

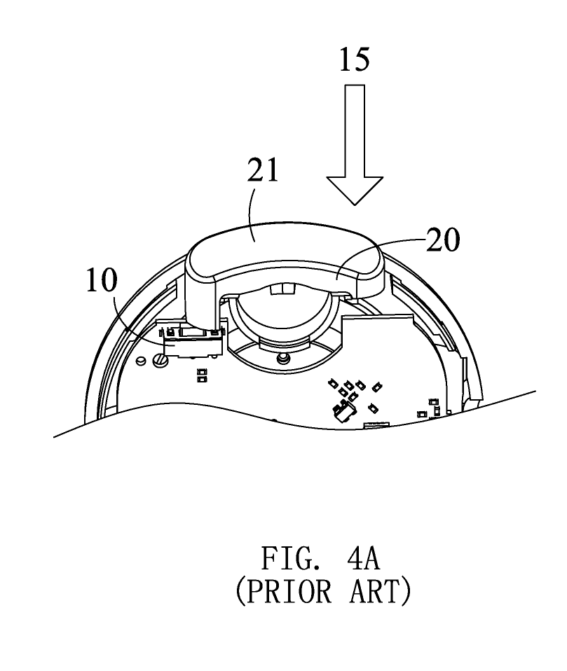

FIG. 4B is a structural schematic view of the prior button device after the working force is applied onto the right side of the button body.

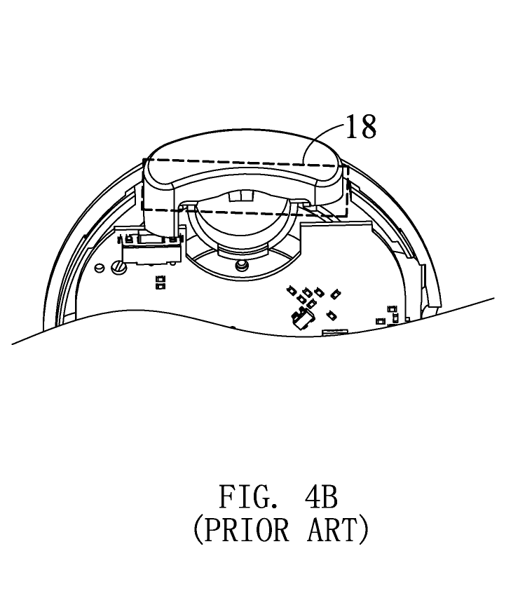

FIG. 5 is a structural schematic view of a button device according to the present invention, wherein a button body keeps horizontally moving.

FIG. 6 is a schematic view of the force analysis when the working force is applied onto the middle of the button body.

### DETAILED DESCRIPTION OF THE PREFERRED EMBODIMENTS

The following embodiment with reference to the accompanying drawings now has been given for detail describing the technology, the feature, the object and the effect of the present invention. It should be noted that the same reference numerals in different drawings represent the same or similar elements. The directions shown in the drawings and mentioned in the following text are normal vectors perpendicular to the corresponding surfaces. The used directional terms are intended to illustrate, but not to limit, the present invention.

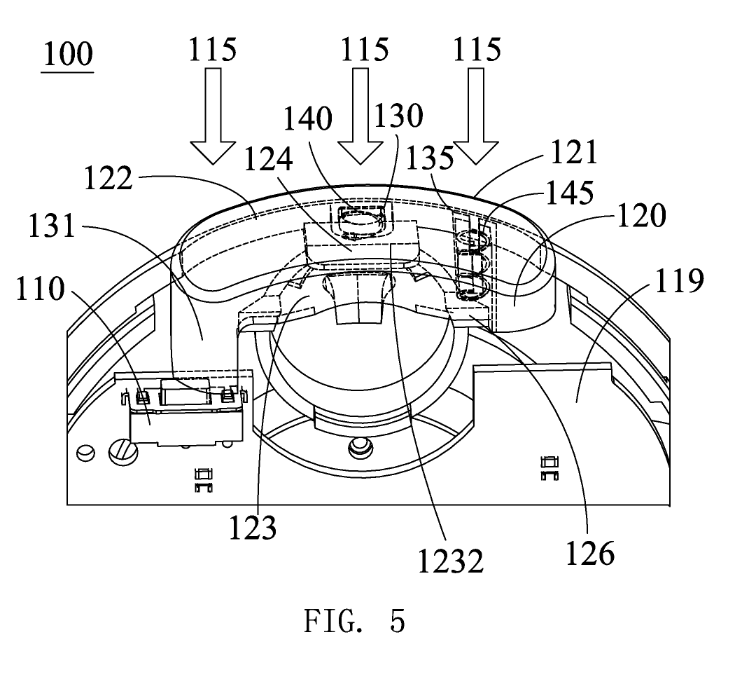

Please refer to FIG. 5, a button device 100 according to the present invention comprises a button body 120 and a circuit board 119.

The button body 120 has a first surface 121, a second surface 122, a vertical wall 123 and a bottom base 131.

The first surface 121 is an arc push surface 21 provided for a user to press.

The second surface 122 is opposite to the first surface 121 and located under the first surface 121. The second surface 122 forms two recesses 130, 135 on the middle and the right of the button body 120, respectively. The recess walls of the two recesses 130, 135 extend along a direction perpendicular to the first surface, and each recess 130(135) accommodates one spring 140(145) therein, respectively. One end of the spring 140(145) enters into or is fixed in the recess 130(135), and the other end of the spring 140(145) extends toward the circuit board 119 to be fixed on a retaining member 124(126) on the circuit board 119. But length of the spring 140 positioned in the recess 130 on the middle of the button body 120 is less than that of the spring 145 positioned in the recess 135 on the right of the button body 120. In this embodiment, the springs 140, 145 are respectively mounted in the recesses 130, 135, but should not be limit to this. Any elastic member, such as a spring tube or a leaf spring and the like being equivalent to the spring, should be included in the present invention.

The vertical wall 123 extends downward from a peripheral edge of the first surface 121 toward the second surface 122, so that the first surface 121 and the vertical wall 123 together define a hollow cavity 1232. The second surface 122 and the recesses 130, 135 are in the hollow cavity.

The bottom base 131 is located on one side of the button body 120 and extends downward from the first surface 121 toward the second surface 122. The extension length of the bottom base 131 is greater than that of the vertical wall 123. In this embodiment, the bottom base 131 is located on the left of the button body 120, but should not be limited to this.

The circuit board 119 has an electronic switch 110 for mechanically touching the bottom base 131 of the button body 120 for switching the specific circuit on the circuit board 119. Because the bottom base 131 is located on the left of the button body 120 and the position of the electronic switch 110 needs to be corresponding to the bottom base 131, the electronic switch 110 is positioned on the upper-left of the circuit board 119 for the convenience of the operation of the circuit board 119.

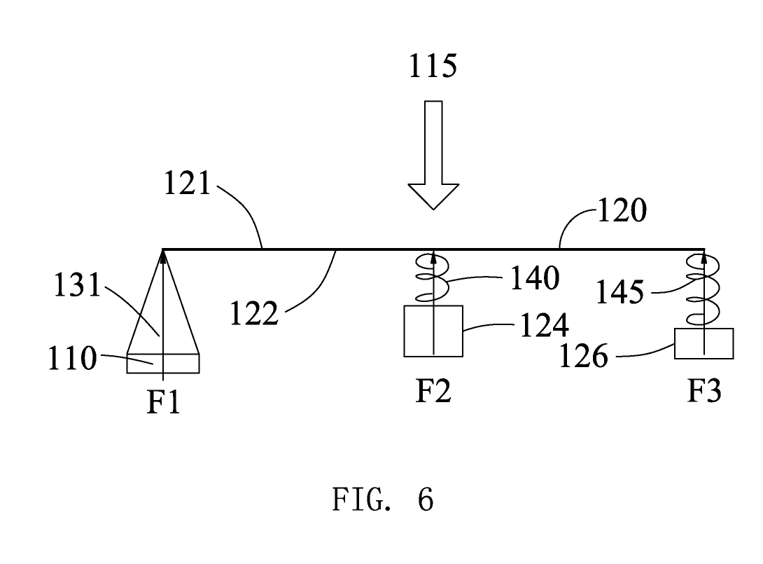

Please refer to FIG. 6, which is an equivalent schematic view of the force analysis when operating the button device 100. As shown in FIG. 6, a cross rod represents above button body 120 having the first surface 121 and the second surface 122. A triangle positioned on the left of the cross rod represents the bottom base 131. FIG. 6 further shows the position relationship of the springs 140, 145, which are respectively located on the middle and the right of the button body 120 and respectively sitting on the retaining members 124, 126. When the user applies a working force 115 onto the button body 120, the bottom base 131 moves downward till mechanically contacting with the electronic switch 110. Now, the electronic switch 110 will provide an upward counterforce Fl, which can be passed through the bottom base 131 unto the left of the button body 120. At the same time, the springs 140, 145 located under the middle and the right of the button body 120 also can be pressed toward the retaining members 124, 126, respectively, so that the pressed springs 140, 145 also can produce the upward counterforces (the rebound forces) F2, F3, which can be passed unto the middle and the right of the button body 120. According to the mechanics principle, the summation of Fl, F2 and F3 is equal to the working force 115 for obtaining a force balance. Therefore, the whole button body 120 can keep horizontally moving downward and has no a tilt problem as occurred in the prior art.

In fact, according to the design of the button device 100 of the present invention, no matter where the user applies the working force 115 unto the first surface 121 of the button body 120, but not being limited to the left, the right or the middle of the first surface 121 of the button body 120, the counterforces produced on the button body 120 can balance the corresponding working force 115 so that obtaining a force balance. The button device 100 of the present invention can improve the handle feeling of the user during the operation and may solve the problem of the button body 120 tilting.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A button device comprising:
a button body having a first surface provided for being pressed, a second surface being opposite to the first surface and located under the first surface, and a bottom base being located on one side of the button body and extending downward from the first surface toward the second surface; and
a circuit board having an electronic switch for mechanically touching the bottom base of the button body;
wherein the button body forms two recesses on the middle and the other side of the button body, respectively; and each of the recesses being formed on the second surface, extending along a direction perpendicular to the first surface and accommodating an elastic member therein.

2. The button device as claimed in claim 1, wherein the button body further includes a vertical wall extending downward from a peripheral edge of the first surface, the first surface and the vertical wall of the button body together define a hollow cavity, and the second surface and the recesses are in the hollow cavity.

3. The button device as claimed in claim 1, wherein the length of the elastic member on the middle of the button device is less than that that of the elastic member on the other side of the button device.

4. The button device as claimed in claim 1, wherein the elastic member may be a spring tube or a leaf spring.
